(19) United States
(12) Patent Application Publication
(10) Pub. No.: US 2026/0304003 A1
(43) Pub. Date: Oct. 1, 2026

(54) IMAGE SENSING DEVICE, IMAGE PROCESSING DEVICE AND IMAGING SYSTEM

(71) Applicant: SK hynix Inc., Gyeonggi-do (KR)

(72) Inventor: Min Hee JO, Gyeonggi-do (KR)

(21) Appl. No.: 19/393,572

(22) Filed: Nov. 19, 2025

(30) Foreign Application Priority Data
Mar. 27, 2025 (KR) 10-2025-0039727

(51) Int. Cl. H04N 25/779; G06T 7/20; H04N 25/772; H04N 25/78

(52) U.S. Cl. CPC H04N 25/779; G06T 7/20; H04N 25/772; H04N 25/78; G06T 2207/10016; G06T 2207/20201

(57) ABSTRACT

An image sensing device is disclosed. The image sensing device includes a pixel array including odd-numbered rows and even-numbered rows, a first row control circuit configured to control the pixel array to perform pixel operations on the odd-numbered rows in a top-to-bottom order, and a second row control circuit configured to control the pixel array to perform the pixel operations on the even-numbered rows in a bottom-to-top order.

### CROSS-REFERENCE TO RELATED APPLICATIONS

This patent document claims the priority and benefits of Korean patent application No. 10-2025-0039727, filed on Mar. 27, 2025, the disclosure of which is incorporated herein by reference in its entirety as part of the disclosure of this patent document.

### TECHNICAL FIELD

The technology and implementations disclosed herein generally relate to an image sensing device, an image processing device, and an imaging system.

### BACKGROUND

An imaging system may capture optical images by converting light into electrical signals using a photosensitive semiconductor material which reacts to light. With the development of automotive, medical, computer and communication industries, the demand for high-performance imaging systems is increasing in various fields such as smartphones, digital cameras, game machines, Internet of Things (IoT), robots, security cameras, and medical micro cameras.

An original image captured by the imaging system may contain image distortion related to moving objects, and therefore it may be necessary to perform image correction for moving objects to improve the performance of the imaging system.

### SUMMARY

Various embodiments of the present disclosure relate to an image sensing device that performs pixel operations in different directions for odd-numbered rows and even-numbered rows of a pixel array.

Various embodiments of the present disclosure relate to an image sensing device that performs pixel operations simultaneously on multiple rows of a pixel array by including multiple row control circuits.

Various embodiments of the present disclosure relate to an image processing device that extracts a moving object from an image.

Various embodiments of the present disclosure relate to an image processing device that corrects image distortion of a moving object in an image.

In accordance with an embodiment of the present disclosure, an image sensing device may include a pixel array including odd-numbered rows and even-numbered rows, a first row control circuit configured to control the pixel array to perform pixel operations on the odd-numbered rows in a top-to-bottom order, and a second row control circuit configured to control the pixel array to perform the pixel operations on the even-numbered rows in a bottom-to-top order.

In some implementations, the pixel operations comprise reset, exposure, and readout.

In some implementations, the first row control circuit is configured to control the pixel array to: after reset of a first odd-numbered row among the odd-numbered rows is stopped, start reset of a second odd-numbered row among the odd-numbered rows, the second odd-numbered row being a next odd-numbered row following the first odd-numbered row.

In some implementations, the first row control circuit is configured to control the pixel array to: after reset of a first odd-numbered row among the odd-numbered rows is stopped, start exposure of the first odd-numbered row.

In some implementations, the first row control circuit is configured to control the pixel array to: after exposure of a first odd-numbered row among the odd-numbered rows is stopped, start readout of the first odd-numbered row.

In some implementations, the second row control circuit is configured to control the pixel array to: after reset of a first even-numbered row among the even-numbered rows is stopped, start reset of a second even-numbered row among the even-numbered rows, the second even-numbered row being an even-numbered row preceding the first even-numbered row.

In some implementations, the second row control circuit is configured to control the pixel array to: after reset of a first even-numbered row among the even-numbered rows is stopped, start exposure of the first even-numbered row.

In some implementations, the second row control circuit is configured to control the pixel array to: after exposure of a first even-numbered row among the even-numbered rows is stopped, start readout of the first even-numbered row.

In some implementations, the first row control circuit is configured to control the pixel array to sequentially perform reset, exposure, and readout of a first row of the pixel array; and the second row control circuit is configured to control the pixel array to perform the reset, exposure, and readout of a last row of the pixel array simultaneously with the reset, exposure, and readout of the first row, and wherein the last row is one of the even-numbered rows of the pixel array.

In some implementations, the first row control circuit is configured to control the pixel array to sequentially perform the reset, exposure, and readout of a third row of the pixel array; and the second row control circuit is configured to control the pixel array to perform the reset, exposure, and readout of an even-numbered row preceding the last row among the even-numbered rows simultaneously with the reset, exposure, and readout of the third row.

In accordance with another embodiment of the present disclosure, an image processing device may include an image generator coupled to a pixel array and configured to generate a first image corresponding to odd-numbered rows of the pixel array and to generate a second image corresponding to even-numbered rows of the pixel array, an image extractor configured to extract a third image including a moving object from the first image and the second image, and an image corrector configured to correct distortion of the moving object in the third image caused by a movement of the moving object.

In some implementations, the image generator may be configured to: generate the first image based on first image data generated by readout of the odd-numbered rows in a top-to-bottom order; and generate the second image based on second image data generated by readout of the even-numbered rows in a bottom-to-top order.

In some implementations, the image extractor may be configured to: vertically invert the second image to generate a vertically inverted second image; and extract the third image using the first image and the vertically inverted second image.

In some implementations, the image extractor may be configured to: extract the third image by performing an XOR operation on the first image and the vertically inverted second image.

In some implementations, the image corrector may be configured to: correct the distortion of the moving object in the third image caused by the movement of the moving object, based on a difference in readout time between rows of the pixel array.

In some implementations, the difference in readout time may be a multiple of a time required to perform reset of one of the rows of the pixel array.

In accordance with yet another embodiment of the present disclosure, an imaging system may include an image sensing device including a pixel array, which includes odd-numbered rows and even-numbered rows and configured to generate first image data by performing pixel operations on the odd-numbered rows in a top-to-bottom order and to generate second image data by performing the pixel operations on the even-numbered rows in a bottom-to-top order, and an image processing device configured to generate a first image based on the first image data, to generate a second image based on the second image data, and to correct distortion of a moving object included in the first image and the second image.

In some implementations, the pixel operations may comprise reset, exposure, and readout.

In some implementations, the image processing device may be configured to: vertically invert the second image to generate a vertically inverted second image; and extract a third image that includes the moving object using the first image and the vertically inverted second image.

In some implementations, the image processing device may be configured to: correct the distortion of the moving object in the third image caused by a movement of the moving object, based on a difference in readout time between rows of the pixel array.

It is to be understood that both the foregoing general description and the following detailed description of the present disclosure are illustrative and explanatory and are intended to provide further explanation of the present disclosure as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an example of an imaging system based on some embodiments of the present disclosure.

FIG. 2 is a block diagram illustrating an image sensing device according to an embodiment of the present disclosure.

FIG. 3 illustrates pixel operations according to an embodiment of the present disclosure.

FIG. 4 is a block diagram illustrating an image processing device according to an embodiment of the present disclosure.

FIG. 5 illustrates pixel operations according to an embodiment of the present disclosure.

FIG. 6 illustrates pixel operations according to an embodiment of the present disclosure.

FIG. 7 illustrates pixel operations according to an embodiment of the present disclosure.

FIG. 8 illustrates pixel operations according to an embodiment of the present disclosure.

FIG. 9 illustrates an image processing method according to an embodiment of the present disclosure.

FIG. 10 is a block diagram showing an example of a computing device corresponding to the image processing device of FIG. 1.

### DETAILED DESCRIPTION

The present disclosure provides implementations and examples of an image sensing device, an image processing device, and an imaging system that may be used in configurations to substantially address one or more technical or engineering issues and to mitigate limitations or disadvantages encountered in some other image sensing devices. Some implementations of the present disclosure relate to an image sensing device that performs pixel operations in different directions for odd-numbered rows and even-numbered rows of a pixel array. Some implementations of the present disclosure relate to an image sensing device that performs pixel operations simultaneously on multiple rows of a pixel array by including multiple row control circuits. Some implementations of the present disclosure relate to an image processing device that extracts a moving object from an image. Some implementations of the present disclosure relate to an image processing device that corrects image distortion of a moving object in an image. In recognition of the issues above, the present disclosure may provide the image sensing device that may perform pixel operations in different directions for odd-numbered rows and even-numbered rows of a pixel array. The present disclosure may provide the image sensing device that may perform pixel operations simultaneously on multiple rows of a pixel array by including multiple row control circuits. The present disclosure may provide the image processing device that may extract a moving object from an image. The present disclosure may provide the image processing device that may correct image distortion of a moving object in an image.

Reference will now be made in detail to the embodiments of the present disclosure, examples of which are illustrated in the accompanying drawings. Wherever possible, the same reference numbers will be used throughout the drawings to refer to the same or like parts. While the present disclosure is susceptible to various modifications and alternative forms, specific embodiments thereof are shown by way of example in the drawings. However, the present disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein.

In the following description of embodiments of the present disclosure, a detailed description of known functions and configurations incorporated herein will be omitted when it may make the subject matter of the present disclosure rather unclear. In the drawings, parts that are not related to a description of the present disclosure are omitted to clearly explain the present disclosure and similar reference numbers will be used throughout this specification to refer to similar parts.

In the present disclosure, when a component is referred to as being “connected”, “coupled”, or “joined” to another component, it may include not only a direct connection relationship but also an indirect connection relationship in which another component is present therebetween. In addition, when a component “comprises”, “includes” or “has” another component, this means that the component does not exclude other components unless specifically stated above but may further include other components.

In the present disclosure, terms such as “first”, “second”, etc. are used only to distinguish one element from other elements and is not used to limit elements, and unless otherwise specified, it does not limit an order or importance, etc., of elements. Accordingly, within a scope of the present disclosure, a first element in an embodiment may be referred to as a second element in another embodiment and likewise, a second element in an embodiment may be referred to as a first element in another embodiment.

In the following description, components are discriminated from each other to clearly describe their characteristics, but this does not mean that they are necessarily physically separated. That is, a plurality of components may be integrated into one hardware or software module and one component may be divided into a plurality of hardware or software modules. Accordingly, integrated or divided embodiments are within the scope of the present disclosure even if not specifically stated.

In the following description, components described with reference to various embodiments are not all necessarily required and some components may be selectively used. Accordingly, embodiments composed of some of the components described in one embodiment are also within the scope of the present disclosure. Further, embodiments implemented by adding components to various embodiments are also within the scope of the present disclosure.

In the present disclosure expressions of positional relationships used in the present specification such as “top”, “upper”, “bottom”, “lower”, “left”, “right”, etc., are employed for the convenience of explanation, and when the drawings illustrated in the present specification are viewed in reverse, the positional relationships described in the specification may be interpreted in the opposite way.

In the present disclosure, each of phrases such as “A or B”, “at least one of A and B”, “at least one of A or B”, “A, B or C”, “at least one of A, B and C”, “and “at least one of A, B, or C” may include any one or all possible combinations of the items listed together in the corresponding one of the phrases. In description of the present disclosure, the term “and/or” may include a combination of a plurality of items or any one of a plurality of listed items. For example, “A or B” may include “only A”, “only B”, or “both A and B”.

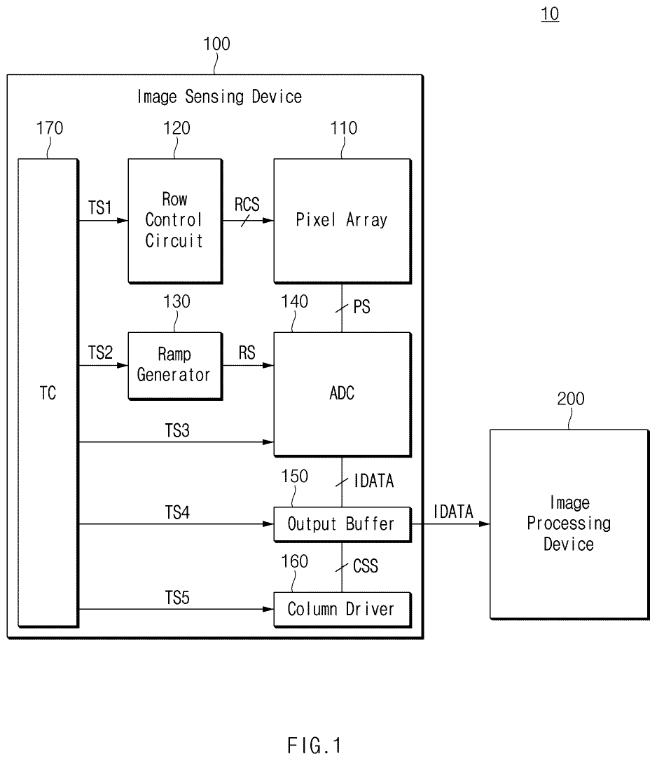

Hereinafter, embodiments of the present disclosure will be described in detail with reference to FIGS. 1 to 10.

FIG. 1 is a block diagram illustrating an example of an imaging system 10 based on some embodiments of the present disclosure.

Referring to FIG. 1, the imaging system 10 may refer to a device, for example, a digital still camera for photographing still images or a digital video camera for photographing moving images. For example, the imaging system 10 may be implemented as a Digital Single Lens Reflex (DSLR) camera, a mirrorless camera, or a smartphone, but is not limited thereto. The imaging system 10 may include a device having an image pickup element such that the device can capture (or photograph) a target object and can thus create an image of the target object.

The imaging system 10 may include an image sensing device 100 and an image processing device 200. The image processing device 200 may correspond to an image signal processor (ISP).

The image sensing device 100 may be a complementary metal oxide semiconductor image sensor (CIS) configured to convert an incident light into an electrical signal. The image sensing device 100 may include a pixel array 110, a row control circuit 120, a ramp generator 130, an analog-to-digital converter (ADC) 140, an output buffer 150, a column driver 160, and a timing controller (TC) 170. The components of the image sensing device 100 are merely illustrative, and at least some components may be added or omitted as needed.

The pixel array 110 may include a plurality of pixels arranged in rows and columns. In one embodiment, the plurality of pixels may be arranged in a two-dimensional (2D) pixel array including rows and columns. In another embodiment, the plurality of image pixels may be arranged in a three-dimensional (3D) pixel array. The plurality of pixels may convert an optical signal into an electrical signal on a pixel basis or a pixel group basis, where the pixels in a pixel group share at least certain internal circuitry. The pixel array 110 may receive row control signals (RCS), including a row selection signal, a pixel reset signal and a transfer signal, from the row control circuit 120. Upon receiving the RCSs, corresponding pixels in the pixel array 110 may be activated to perform the operations corresponding to the row selection signal, the pixel reset signal, and the transfer signal.

Each pixel in the pixel array 110 may have at least two different sensitivities. Here, the sensitivity may mean an increase in amount of image data IDATA (or an increase in amount of a response) with respect to an increase in amount of the intensity of incident light. That is, as the sensitivity increases, the amount of increase in image data IDATA in response to an increase in the intensity of incident light increases. As the sensitivity decreases, the amount of increase in image data IDATA in response to an increase in the intensity of incident light decreases. In the present disclosure, the sensitivity may be determined by a conversion gain.

The row control circuit 120 may activate the pixel array 110 to perform specific operations on the pixels included in the corresponding row based on commands and control signals (TS1) provided by the timing controller (TC) 170. The row control circuit 120 may include a row driver. In some embodiments, the row control circuit 120 may select at least one pixel arranged in at least one row of the pixel array 110. The row control circuit 120 may generate a row selection signal to select at least one row among the plurality of rows. The row control circuit 120 may sequentially enable the pixel reset signal and the transfer signal for the pixels corresponding to the at least one selected row. Thus, a reference signal and an image signal, which are analog signals generated by each of the pixels of the selected row, may be sequentially transferred to the ADC 140. The reference signal may be an electrical signal that is provided to the ADC 140 when a sensing node of a pixel (e.g., a floating diffusion region) is reset. The image signal may be an electrical signal that is provided to the ADC 140 when photocharges generated by the pixel are accumulated in the sensing node. The reference signal indicating unique reset noise of each pixel and the image signal indicating the intensity of incident light may be generically referred to as a pixel signal.

The complementary metal oxide semiconductor (CMOS) image sensor may use the correlated double sampling (CDS) to remove undesired offset values of pixels known as the fixed pattern noise by sampling a pixel signal twice to remove the difference between two samples. In one example, the CDS may remove the undesired offset value of pixels by comparing pixel output voltages obtained before and after photocharges generated by incident light are accumulated in the sensing node such that only pixel output voltages based on the incident light can be measured. In some embodiments, the ADC 140 may sequentially sample and hold the reference signal and the image signal, which are provided from each of a plurality of column lines from the pixel array 110.

The ramp generator 130 may generate a ramp signal (RS) required for the analog-to-digital conversion operation of the ADC 140 upon receiving a timing signal (TS2) from the timing controller (TC) 170, and may supply the ramp signal (RS) to the ADC 140.

The ADC 140 may sample and hold the pixel signal from each column line of the pixel array 110 based on a timing signal (TS3) of the timing controller (TC) 170, may convert the resultant signal into digital signals, and may output the digital signals. In some embodiments, the ADC 140 may be implemented as a ramp-compare type ADC. The ramp-compare type ADC may include a comparator circuit for comparing the analog pixel signal with a ramp signal that ramps up or down over time, and a counter for performing counting until the ramp signal matches the analog pixel signal.

The output buffer 150 may temporarily hold or store the column-based image data (i.e., data (IDATA) obtained through digital conversion of the pixel signal) provided from the ADC 140 to output the stored image data. The image data IDATA output from the ADC 140 may be temporarily stored in the output buffer 150 based on a timing signal (TS4) of the timing controller (TC) 170. The output buffer 150 may provide an interface to compensate for differences in data rate or transfer rate between the image sensing device 100 and other devices.

The column driver 160 may select a column of the output buffer 150 based on a control signal (TS5) from the timing controller (TC) 170, and may control the output buffer 150 to sequentially output the image data IDATA, which are temporarily stored in the selected column of the output buffer 150. In some embodiments, upon receiving an address signal from the timing controller (TC) 170, the column driver 160 may generate a column selection signal (CSS) based on the address signal and may select a column of the output buffer 150, thereby outputting the image data IDATA as an output signal from the selected column of the output buffer 150.

The timing controller (TC) 170 may control operations of at least one of the row control circuit 120, the ramp generator 130, the ADC 140, the output buffer 150, or the column driver 160.

The timing controller (TC) 170 may provide at least one of the row control circuit 120, the ramp generator 130, the ADC 140, the output buffer 150, or the column driver 160 with a clock signal required for the operations of the respective components of the image sensing device 100, a control signal for timing control, and address signals for selecting a row or column. In some embodiments, the timing controller (TC) 170 may include a logic control circuit, a phase-locked loop (PLL) circuit, a timing control circuit, and a communication interface circuit.

The image processing device 200 may perform image signal processing on the image data IDATA received from the image sensing device 100. The image processing device 200 may reduce noise in the image data IDATA, and may perform various kinds of image signal processing, such as interpolation, synthesis, gamma correction, color filter array interpolation, color matrix, color correction, color enhancement, and lens distortion correction, for image-quality improvement of the image data IDATA. In addition, the image processing device 200 may compress image data that has been created by execution of image signal processing for image-quality improvement, such that the image processing device 200 can create an image file using the compressed image data. Alternatively, the image processing device 200 may recover image data from the image file. In this case, the format for compressing such image data may be a reversible format or an irreversible format. As an example of the compression format, for a still image, Joint Photographic Experts Group (JPEG) format, JPEG 2000 format, or the like may be used. In addition, for moving images, a plurality of frames may be compressed according to Moving Picture Experts Group (MPEG) standards to create moving image files. For example, image files may be created according to Exchangeable image file format (Exif) standards.

The image processing device 200 may generate a high dynamic range (HDR) image by synthesizing at least two images having different sensitivities. For example, the image sensing device 100 may output a low-sensitivity image generated from a low-sensitivity pixel (e.g., a low conversion gain (LCG) pixel) with a relatively lower sensitivity and a high-sensitivity image generated from a high-sensitivity pixel (e.g., a high conversion gain (HCG) pixel) with a relatively higher sensitivity. The image processing device 200 may combine the low-sensitivity image and the high-sensitivity image to generate an HDR image. Here, the low-sensitivity and the high-sensitivity may correspond to relative concepts, and the image sensing device 100 may generate image data IDATA having at least N different sensitivities (where N is an integer greater than or equal to 2). The image processing device 200 may generate HDR images from the image data IDATA.

The image processing device 200 may transmit the image data, for which the image processing operation has been completed, to a host device (not shown). The host device (not shown) may be a processor (e.g., an application processor) for processing the image-processed image data received from the image processing device 200, a memory (e.g., a non-volatile memory) for storing the image data, or a display device (e.g., a liquid crystal display (LCD)) for visually displaying the image data.

The image processing device 200 may transmit, to the image sensing device 100, a control signal for controlling operations (e.g., whether or not to operate, an operation timing, an operation mode, etc.) of the image sensing device 100.

The imaging system 10 may include an image sensing device 100 that generates first image data by performing pixel operations in a top-to-bottom order for the odd-numbered rows of a pixel array 110, and generates second image data by performing pixel operations in a bottom-to-top order for the even-numbered rows of the pixel array 110. In addition, the imaging system 10 may include an image processing device 200 that generates a first image based on the first image data, generates a second image based on the second image data, and corrects distortion of a moving object included in the first image and the second image. More detailed descriptions of the image sensing device 100 and the image processing device 200 included in the imaging system 10 will be provided below.

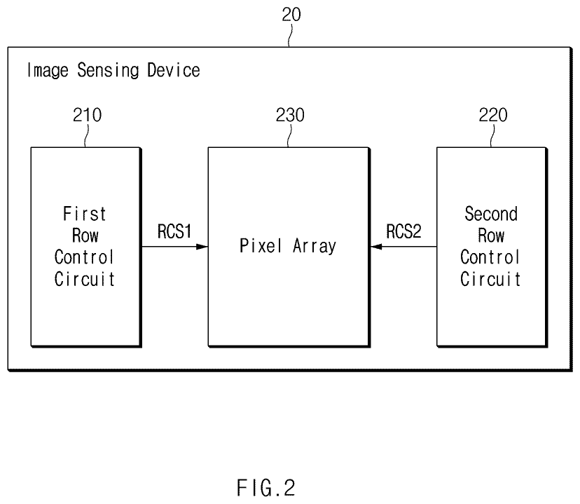

FIG. 2 is a block diagram illustrating an image sensing device 20 according to an embodiment of the present disclosure.

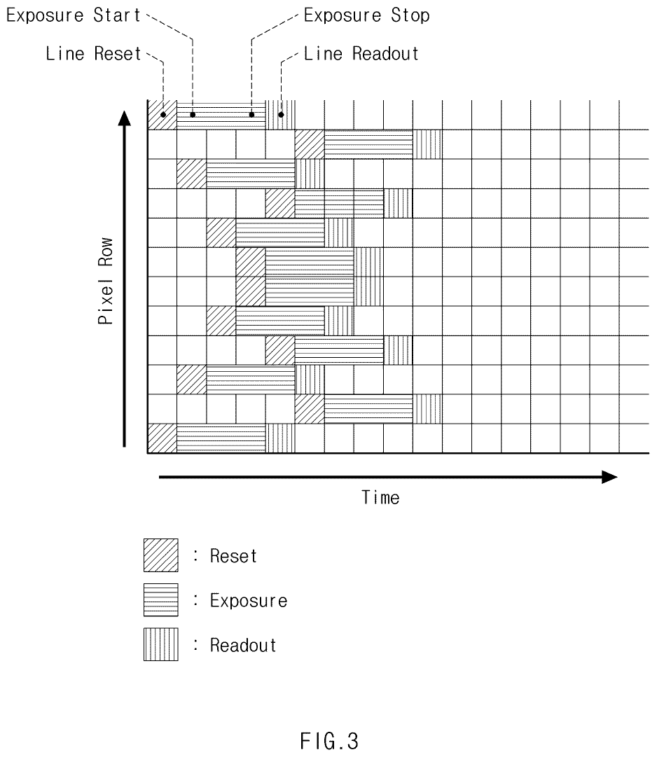

FIG. 3 illustrates pixel operations according to an embodiment of the present disclosure.

FIG. 2 will now be described with reference to FIG. 3.

Referring to FIG. 2, the image sensing device 20 may include a first row control circuit 210, a second row control circuit 220, and a pixel array 230. The image sensing device 20 may correspond to the image processing device 200 of FIG. 1.

The first row control circuit 210 may control the pixel array 230 such that pixel operations are performed on particular rows (e.g., the odd-numbered rows) of the pixel array 230 in a top-to-bottom order. Alternatively, the first row control circuit 210 may control the pixel array 230 such that pixel operations are performed on the odd-numbered rows of the pixel array 230 in a bottom-to-top order. The pixel operations may include reset, exposure, and readout.

For example, referring to FIG. 3, the first row control circuit 210 may control the pixel array 230 such that pixel operations are performed on the odd-numbered rows of the pixel array 230 in a top-to-bottom order. Specifically, the first row control circuit 210 may control the pixel array 230 such that, immediately after the reset of a first odd-numbered row is stopped, the reset of a second odd-numbered row, which is the next odd-numbered row after the first odd-numbered row, is started. For example, the first row control circuit 210 may control the pixel array 230 such that, immediately after the reset of the first row is stopped, the reset of the third row is started. In addition, the first row control circuit 210 may control the pixel array 230 such that, immediately after the reset of the first odd-numbered row is stopped, exposure of the first odd-numbered row is started. Furthermore, the first row control circuit 210 may control the pixel array 230 such that, immediately after the exposure of the first odd-numbered row is stopped, readout of the first odd-numbered row is started. In addition, the first row control circuit 210 may control the pixel array 230 such that, immediately after the reset of the second odd-numbered row is stopped, exposure of the second odd-numbered row is started. Furthermore, the first row control circuit 210 may control the pixel array 230 such that, immediately after the exposure of the second odd-numbered row is stopped, readout of the second odd-numbered row is started.

The second row control circuit 220 may control the pixel array 230 such that pixel operations are performed on the even-numbered rows of the pixel array 230 in a bottom-to-top order. Alternatively, the second row control circuit 220 may control the pixel array 230 such that pixel operations are performed on the even-numbered rows of the pixel array 230 in a top-to-bottom order.

For example, referring to FIG. 3, the second row control circuit 220 may control the pixel array 230 such that pixel operations are performed on the even-numbered rows of the pixel array 230 in a bottom-to-top order. Specifically, the second row control circuit 220 may control the pixel array 230 such that, immediately after the reset of a first even-numbered row is stopped, the reset of a second even-numbered row, which is the previous even-numbered row preceding the first even-numbered row, is started. For example, the second row control circuit 220 may control the pixel array 230 such that, immediately after the reset of the twelfth row is stopped, the reset of the tenth row is started. In addition, the second row control circuit 220 may control the pixel array 230 such that, immediately after the reset of the first even-numbered row is stopped, exposure of the first even-numbered row is started. Furthermore, the second row control circuit 220 may control the pixel array 230 such that, immediately after the exposure of the first even-numbered row is stopped, readout of the second even-numbered row is started. In addition, the second row control circuit 220 may control the pixel array 230 such that, immediately after the reset of the second even-numbered row is stopped, exposure of the second even-numbered row is started. Furthermore, the second row control circuit 220 may control the pixel array 230 such that, immediately after the exposure of the second even-numbered row is stopped, readout of the second even-numbered row is started.

The first row control circuit 210 and the second row control circuit 220 may control the pixel array 230 such that pixel operations are simultaneously performed on different rows of the pixel array 230. Specifically, the second row control circuit 220 may control the pixel array 230 such that the reset, exposure, and readout of the last row (for example, the twelfth row in FIG. 3) of the pixel array are performed simultaneously with the reset, exposure, and readout of the first row of the pixel array. In this case, the last row may be one of the even-numbered rows of the pixel array. In addition, the second row control circuit 220 may control the pixel array 230 such that the reset, exposure, and readout of the even-numbered row (for example, the tenth row in FIG. 3) preceding the last row are performed simultaneously with the reset, exposure, and readout of the third row. In other words, assuming that the pixel array 230 includes twelve rows as shown in FIG. 3, the reset, exposure, and readout of the first row may be performed simultaneously with the reset, exposure, and readout of the twelfth row. In addition, the reset, exposure, and readout of the third row may be performed simultaneously with the reset, exposure, and readout of the tenth row. In addition, the reset, exposure, and readout of the fifth row may be performed simultaneously with the reset, exposure, and readout of the eighth row. Further, the reset, exposure, and readout of the sixth row may be performed simultaneously with the reset, exposure, and readout of the seventh row.

The pixel array 230 may correspond to the pixel array 110 of FIG. 1. The pixel array 230 may receive a first row control signal RCS1 from the first row control circuit 210 and a second row control signal RCS2 from the second row control circuit 220. Pixel operations may be performed according to the first row control signal RCS1 and the second row control signal RCS2.

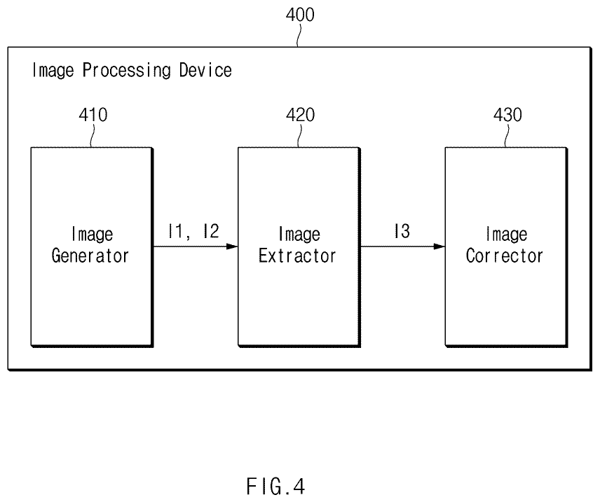

FIG. 4 is a block diagram illustrating an image processing device according to an embodiment of the present disclosure.

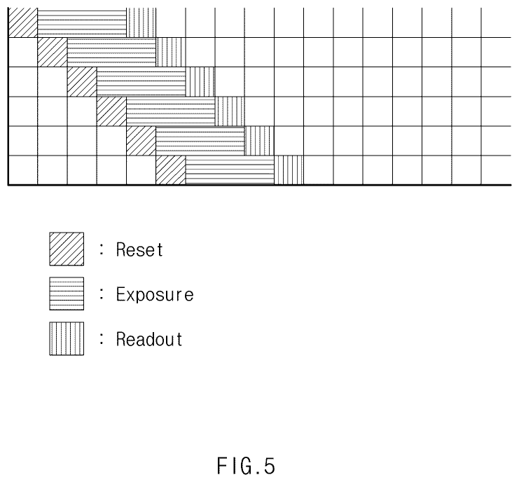

FIG. 5 illustrates pixel operations according to an embodiment of the present disclosure.

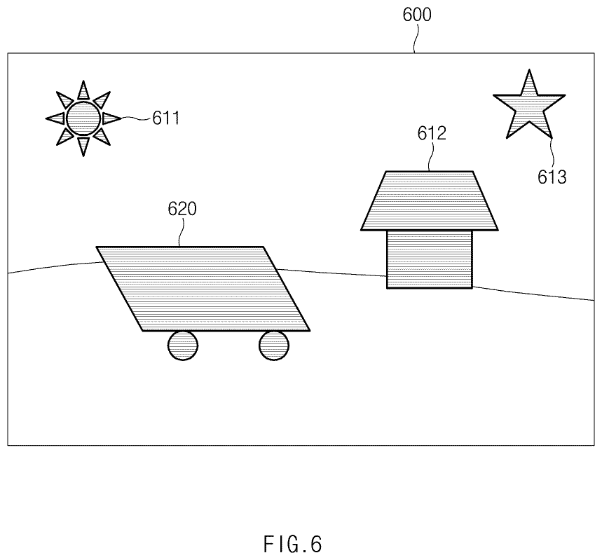

FIG. 6 illustrates pixel operations according to an embodiment of the present disclosure.

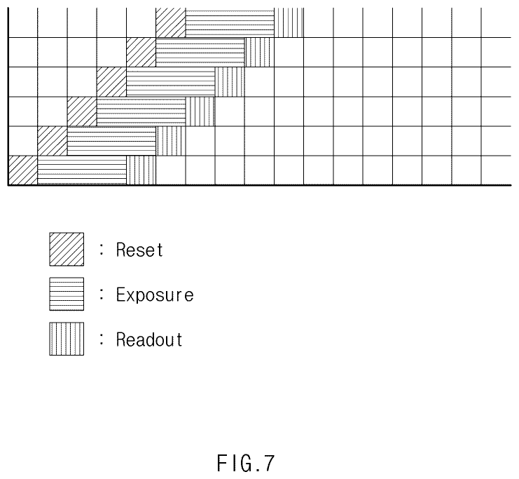

FIG. 7 illustrates pixel operations according to an embodiment of the present disclosure.

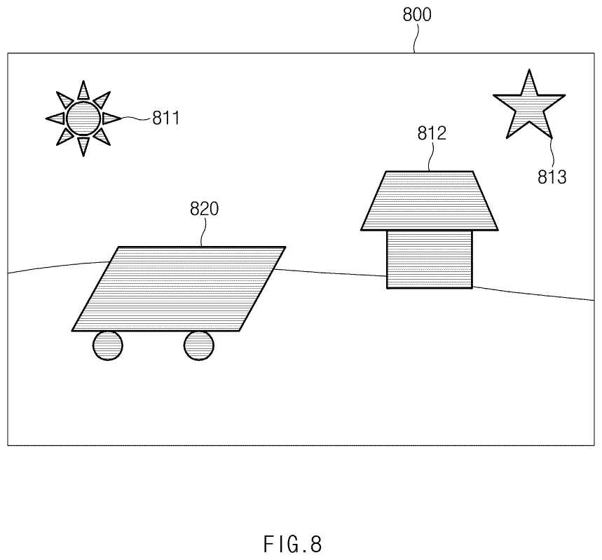

FIG. 8 illustrates pixel operations according to an embodiment of the present disclosure.

FIG. 4 will now be described with reference to FIGS. 3, 5, 6, 7, and 8.

Referring to FIG. 4, the image processing device 400 may include an image generator 410, an image extractor 420, and an image corrector 430.

The image generator 410 may generate a first image corresponding to the odd-numbered rows of the pixel array and a second image corresponding to the even-numbered rows of the pixel array. Specifically, the image generator 410 may generate the first image based on first image data generated by reading out the odd-numbered rows in a top-to-bottom order. For example, FIG. 5 illustrates pixel operations performed on the odd-numbered rows of FIG. 3. Referring to FIG. 5, pixel operations may be performed on the rows (e.g., the odd-numbered rows in FIG. 3) of the pixel array in a top-to-bottom order. Therefore, the image generator 410 may generate the first image based on the first image data generated by reading out the rows in FIG. 5. For example, using the readout method of FIG. 5, the first image 600 in FIG. 6 may be generated. The first image 600 may include static objects 611, 612, and 613, which are stationary objects, and a dynamic object 620, which is a moving object.

In addition, the image generator 410 may generate the second image based on second image data generated by reading out the even-numbered rows in a bottom-to-top order. For example, FIG. 7 illustrates pixel operations performed on the even-numbered rows in FIG. 3. Referring to FIG. 7, pixel operations may be performed on the rows (e.g., the even-numbered rows in FIG. 3) of the pixel array in a bottom-to-top order. Therefore, the image generator 410 may generate the second image based on the second image data generated by reading out the rows in FIG. 7. For example, using the readout method of FIG. 7, the second image may be generated. Referring to FIG. 8, the second image 800 may be an image obtained by vertically inverting the second image generated based on the second image data. The vertically inverted image for the second image 800 may include static objects 811, 812, and 813, which are stationary objects, and a dynamic object 820, which is a moving object.

The times at which the respective rows of the pixel array are read out may be different from each other, and the direction of pixel operations performed on the odd-numbered rows is different from the direction of pixel operations performed on the even-numbered rows. Accordingly, the dynamic object 620 in FIG. 6 and the dynamic object 820 in FIG. 8, which are the same object, may be imaged in different shapes. For example, the dynamic objects 620 and 820 may correspond to a vehicle moving to the right.

The image extractor 420 may extract a third image of the dynamic objects 620 and 820 from the first image 600 and the second image 800. Specifically, the image extractor 420 may generate a vertically inverted second image 800 by vertically inverting the second image, and then extract the third image from the first image 600 and the vertically inverted second image 800. The image extraction will be described in more detail later.

The image corrector 430 may correct distortion in the third image caused by the movement of the dynamic objects 620 and 820. For example, the image corrector 430 may correct distortion in the third image caused by the movement of the dynamic objects 620 and 820, based on the difference in readout time between the rows of the pixel array. The image correction will be described in more detail later.

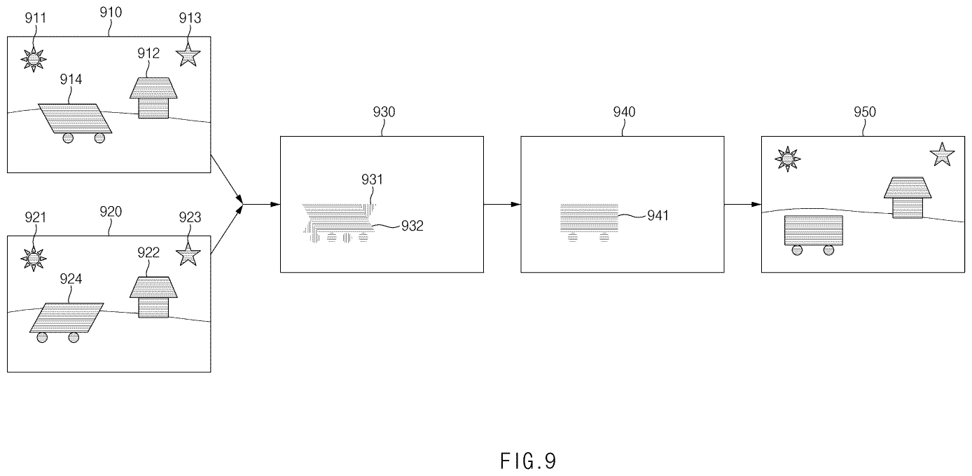

FIG. 9 illustrates an image processing method according to an embodiment of the present disclosure.

Referring to FIG. 9, an image processing device according to the embodiment of the present disclosure may generate a first image 910 and a vertically inverted second image 920. The first image 910 and the vertically inverted second image 920 may correspond to the first image 600 in FIG. 6 and the vertically inverted second image 800 in FIG. 8, respectively. Specifically, the first image 910 may be generated based on first image data generated by reading out the odd-numbered rows of the pixel array of the image sensing device in a top-to-bottom order. The vertically inverted second image 920 may be generated based on second image data generated by reading out the even-numbered rows of the pixel array of the image sensing device in a bottom-to-top order. The first image 910 may include static objects 911, 912, and 913, which are stationary objects, and a dynamic object 914, which is a moving object. The vertically inverted second image 920 may include static objects 921, 922, and 923, which are stationary objects, and a dynamic object 924, which is a moving object.

The image extractor of the image processing device may extract a third image 930 of the dynamic objects 914 and 924 from the first image 910 and the vertically inverted second image 920. For example, the image extractor may perform an exclusive OR (XOR) operation on the first image 910 and the vertically inverted second image 920 to extract the third image 930. Specifically, the static objects 911, 912, and 913 in the first image 910 and the static objects 921, 922, and 923 in the vertically inverted second image 920 are the same stationary objects, and accordingly they may be imaged identically even though the readout times of individual rows differ. In contrast, the dynamic object 914 in the first image 910 and the dynamic object 924 in the vertically inverted second image 920 are the same object that is present at different locations at different times. Thus, for the dynamic objects, the readout times of the respective rows are different from each other, and the direction of readout of the odd-numbered rows is different from the direction of readout of the even-numbered rows. Accordingly, the dynamic objects may be imaged differently. Therefore, performing an XOR operation on the first image 910 and the vertically inverted second image 920 may result in a third image 930 containing only the dynamic objects 914 and 924 that are imaged differently (for example a combined image that includes the dynamic objects 914 and 924). In the third image 930, the object 931 may correspond to the dynamic object 924, and the object 932 may correspond to the dynamic object 914.

The image corrector of the image processing device may correct distortion in the third image 930 caused by the movement of an object based on the difference in readout time between the rows of the pixel array of the image sensing device. The difference in readout time between the rows may be a multiple of a specific time. For example, referring to FIG. 3, the difference in readout time between the rows may be a multiple of the time required to perform the reset operation on a single row of the pixel array. Specifically, the first row and second row in FIG. 3 may be read out with a time difference equal to five times the duration of the reset operation. Additionally, the first row and third row may be read out with a time difference equal to one time the duration of the reset operation. Considering the different readout timings for the respective rows, the image corrector may correct the third image to generate a fourth image 940 that includes a dynamic object 941 free from the distortion caused by the movement. In addition, the image processing device may generate a fifth image 950 without distortion, which includes the distortion-corrected dynamic object 941 and the static objects 911, 912, 913, 921, 922, and 923, (for example corresponding to a static object for each of 911 and/or 921, 912 and/or 922, and 913 and/or 923) based on the first image 910, the second image 920, or the fourth image 940.

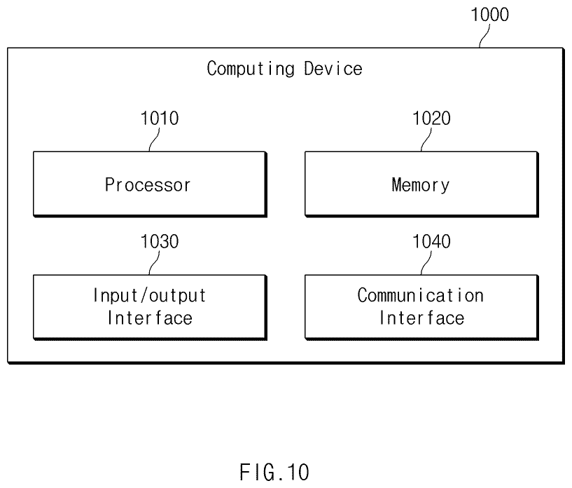

FIG. 10 is a block diagram showing an example of a computing device 1000 corresponding to the image processing device of FIG. 1.

Referring to FIG. 10, the computing device 1000 may represent an embodiment of a hardware configuration for performing the operation of the image processing device 200 of FIG. 1.

The computing device 1000 may be mounted on a chip that is independent from the chip on which the image sensing device is mounted. According to one embodiment, the chip on which the image sensing device is mounted and the chip on which the computing device 1000 is mounted may be implemented in one package, for example, a multi-chip package (MCP), but the scope of the present disclosure is not limited thereto.

Additionally, the internal configuration or arrangement of the computing device 1000 and the image sensing device may vary depending on the embodiment. For example, at least a portion of the image sensing device may be included in the computing device 1000. Alternatively, at least a portion of the computing device 1000 may be included in the image sensing device. In this instance, at least a portion of the computing device 1000 may be mounted together on a chip on which the image sensing device is mounted.

The computing device 1000 may include a processor 1010, a memory 1020, an input/output (I/O) interface 1030, and a communication interface 1040.

The processor 1010 may process data and/or instructions required to perform the operations of the components of the image processing device 200 described in FIG. 1.

The memory 1020 may store data and/or instructions required to perform operations of the components of the image processing device 200, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), Electrically Erasable PROM (EEPROM), flash memory, etc.).

That is, the computer program for performing the operations of the image processing device 200 disclosed in the present disclosure may be recorded in the memory 1020 and executed and processed by the processor 1010, thereby implementing the operations of the image processing device 200.

The input/output (I/O) interface 1030 may be an interface that connects an external input device (e.g., keyboard, mouse, touch panel, etc.) and/or an external output device (e.g., display) to the processor 1010 to allow data to be transmitted and received.

The communication interface 1040 is a component capable of transmitting and receiving various data to and from an external device (e.g., an application processor, external memory, etc.), and may be a device capable of supporting wired or wireless communication.

As is apparent from the above description, the image sensing device according to some embodiments of the present disclosure may perform pixel operations in different directions for odd-numbered rows and even-numbered rows of a pixel array.

The image sensing device according to some embodiments of the present disclosure may perform pixel operations simultaneously on multiple rows of a pixel array by including multiple row control circuits.

The image processing device according to some embodiments of the present disclosure may extract a moving object from an image.

The image processing device according to some embodiments of the present disclosure may correct image distortion of a moving object in an image.

The embodiments of the present disclosure may provide a variety of effects capable of being directly or indirectly recognized through the above-mentioned patent document.

Those skilled in the art will appreciate that the present disclosure may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in this patent document.

What is claimed is:

1. An image sensing device comprising:
a pixel array including odd-numbered rows and even-numbered rows;
a first row control circuit configured to control the pixel array to perform pixel operations on the odd-numbered rows in a top-to-bottom order; and
a second row control circuit configured to control the pixel array to perform the pixel operations on the even-numbered rows in a bottom-to-top order.

2. The image sensing device according to claim 1, wherein:
the pixel operations comprise reset, exposure, and readout.

3. The image sensing device according to claim 1, wherein the first row control circuit is configured to control the pixel array to:
after reset of a first odd-numbered row among the odd-numbered rows is stopped, start reset of a second odd-numbered row among the odd-numbered rows, the second odd-numbered row being a next odd-numbered row following the first odd-numbered row.

4. The image sensing device according to claim 1, wherein the first row control circuit is configured to control the pixel array to:
after reset of a first odd-numbered row among the odd-numbered rows is stopped, start exposure of the first odd-numbered row.

5. The image sensing device according to claim 1, wherein the first row control circuit is configured to control the pixel array to:
after exposure of a first odd-numbered row among the odd-numbered rows is stopped, start readout of the first odd-numbered row.

6. The image sensing device according to claim 1, wherein the second row control circuit is configured to control the pixel array to:
after reset of a first even-numbered row among the even-numbered rows is stopped, start reset of a second even-numbered row among the even-numbered rows, the second even-numbered row being an even-numbered row preceding the first even-numbered row.

7. The image sensing device according to claim 1, wherein the second row control circuit is configured to control the pixel array to:
after reset of a first even-numbered row among the even-numbered rows is stopped, start exposure of the first even-numbered row.

8. The image sensing device according to claim 1, wherein the second row control circuit is configured to control the pixel array to:
after exposure of a first even-numbered row among the even-numbered rows is stopped, start readout of the first even-numbered row.

9. The image sensing device according to claim 1, wherein:
the first row control circuit is configured to control the pixel array to sequentially perform reset, exposure, and readout of a first row of the pixel array; and
the second row control circuit is configured to control the pixel array to perform the reset, exposure, and readout of a last row of the pixel array simultaneously with the reset, exposure, and readout of the first row, and
wherein the last row is one of the even-numbered rows of the pixel array.

10. The image sensing device according to claim 9, wherein:
the first row control circuit is configured to control the pixel array to sequentially perform the reset, exposure, and readout of a third row of the pixel array; and
the second row control circuit is configured to control the pixel array to perform the reset, exposure, and readout of an even-numbered row preceding the last row among the even-numbered rows simultaneously with the reset, exposure, and readout of the third row.

11. An image processing device comprising:
an image generator coupled to a pixel array and configured to
generate a first image corresponding to odd-numbered rows of the pixel array, and
generate a second image corresponding to even-numbered rows of the pixel array;
an image extractor configured to extract a third image including a moving object from the first image and the second image; and
an image corrector configured to correct distortion of the moving object in the third image caused by a movement of the moving object.

12. The image processing device according to claim 11, wherein the image generator is configured to:
generate the first image based on first image data generated by readout of the odd-numbered rows in a top-to-bottom order; and
generate the second image based on second image data generated by readout of the even-numbered rows in a bottom-to-top order.

13. The image processing device according to claim 11, wherein the image extractor is configured to:
vertically invert the second image to generate a vertically inverted second image; and
extract the third image using the first image and the vertically inverted second image.

14. The image processing device according to claim 13, wherein the image extractor is configured to:
extract the third image by performing an XOR operation on the first image and the vertically inverted second image.

15. The image processing device according to claim 11, wherein the image corrector is configured to:
correct the distortion of the moving object in the third image caused by the movement of the moving object, based on a difference in readout time between rows of the pixel array.

16. The image processing device according to claim 15, wherein:
the difference in readout time is a multiple of a time required to perform reset of one of the rows of the pixel array.

17. An imaging system comprising:
an image sensing device including a pixel array, which includes odd-numbered rows and even-numbered rows and configured to:
generate first image data by performing pixel operations on the odd-numbered rows in a top-to-bottom order; and
generate second image data by performing the pixel operations on the even-numbered rows in a bottom-to-top order; and
an image processing device configured to:
generate a first image based on the first image data;
generate a second image based on the second image data; and
correct distortion of a moving object included in the first image and the second image.

18. The imaging system according to claim 17, wherein:
the pixel operations comprise reset, exposure, and readout.

19. The imaging system according to claim 17, wherein the image processing device is configured to:
vertically invert the second image to generate a vertically inverted second image; and
extract a third image that includes the moving object using the first image and the vertically inverted second image.

20. The imaging system according to claim 19, wherein the image processing device is configured to:
correct the distortion of the moving object in the third image caused by a movement of the moving object, based on a difference in readout time between rows of the pixel array.
